(19) United States
(12) Patent Application Publication
(10) Pub. No.: US 2006/0161705 A1
(43) Pub. Date: Jul. 20, 2006

(54) Method for regulating a transmission with short data telegrams

(76) Inventors: Stephan Schultze, Lohr am Main (DE); Rigobert Kynast, Lohr am Main (DE); Ludwig Leurs, Lohr am Main (DE); Thomas Schmid, Hafenlohr (DE)

Correspondence Address: KENYON & KENYON LLP, ONE BROADWAY, NEW YORK, NY, 10004, US

(21) Appl. No.: 11/299,196

(22) Filed: Dec. 9, 2005

(30) Foreign Application Priority Data
Dec. 21, 2004 (DE) 10 2004 062 683.9

(51) Int. Cl. G06F 13/42

(52) U.S. Cl. 710/106

(57) ABSTRACT

A method for regulating a transmission of a quantity of user data between a plurality of users of a communication system via a field-bus system is provided, in which method the individual users communicate by way of data telegrams, each data telegram containing at least one destination address, one source address and a quantity of user data not exceeding a predefined, maximum quantity. In the event the maximum quantity of user data predefined for one data telegram is less than the quantity of user data to be transmitted, the quantity of user data to be transmitted is fragmented into a plurality of partial telegrams, and the respective partial telegrams are transmitted one after another in a defined sequence of partial telegrams.

### FIELD OF THE INVENTION

The present invention relates to a method and a communication system for regulating a transmission of a quantity of user data between a plurality of users of a communication system via a field bus system using data telegrams.

### BACKGROUND INFORMATION

In a communication system having cyclic communication, data telegrams are exchanged between users or corresponding stations. In a cyclic communication, a so-called synchronization telegram (MST—master synchronization telegram), which is always produced in fixed time intervals, is transmitted cyclically, e.g., by one user characterized as master. Such a synchronization telegram, which may also be embedded in a so-called master data telegram, starts a time control in every other system user characterized as slave. After expiration of the time stipulated in the initialization, each user transmits its telegram, also known as drive telegram (AT), to the master. At the end of such a cycle, for example, the master sends out a master data telegram (MDT) as broadcast which contains all data for all slaves. From the initialization, each slave knows the position of the data addressed to it within the master data telegram.

Alternatively, however, as already indicated, the synchronization telegram may be embedded in the master data telegram, which is then transmitted as broadcast right at the beginning of a cycle.

A communication system used in this context may be a so-called Ethernet, for example. An Ethernet is a frame-based computer networking technology for local area networks such as so-called LANs (local area network). Cable types and signaling for a physical layer, and packet formats and protocols for a medium access control/link layer of the so-called OSI model are defined. The Ethernet is essentially standardized in the IEEE standard 802.3. The Ethernet is based on the idea that all users of a network send messages through a type of radio system, however only within a shared line network. Each user has a globally unique 48-bit key known as its MAC address. The total communication within the communication system passes on the same line. This means that any information or all data which was sent by one computer or one user can be received by all other users. This fact can be utilized by protocols on higher layers in order to transmit broadcast messages to all connected users. At present, there are four types of so-called Ethernet frames. The different frame types have different format and packet sizes, but can be used in parallel on the same physical medium. Within the Ethernet, there are maximum packet lengths or telegram sizes, known as MTU (maximum transmission unit), predefined for all usable Ethernet frames. This telegram size is approximately 1,500 bytes, which limits the information able to be transmitted in one telegram.

One conceivable exemplary embodiment includes, for instance, one master station and a plurality of tributary stations. In this case, for efficiency reasons, data telegrams may be sent as so-called collective telegrams, in which data for a plurality of tributary stations is contained in one telegram. Each addressed tributary station knows where the information intended for it is contained in the collective telegram. In this instance, the master station and the plurality of tributary stations are usually connected to each other via a so-called field-bus system. The field bus replaces parallel line groups by a single bus cable, and at the same time connects all levels and all components linked to the system. In this context, the components of the system may be distributed arbitrarily in the field, for all are connected locally in decentralized fashion.

Data telegrams, via which the data is sent, include at least one destination address, one source address and a field for user data to be transmitted. In a cyclic communication, it is further necessary to carry out or to ensure a synchronization. As already mentioned, synchronization information necessary for this purpose can be transmitted separately via a synchronization telegram. Alternatively, such a so-called master synchronization telegram (MST) can be embedded in a data field of a normal data telegram. Each communication cycle has a specific time duration, within which data telegrams are transmitted between the master station and the plurality of tributary stations. For example, the master station transmits a so-called master data telegram (MDT) as a collective telegram having embedded synchronization information MST to all tributary stations connected to the system. The MDT may contain setpoint values, for instance. Each addressed tributary station knows where the information intended for it is filed within the collective telegram. The individual tributary stations are now able to communicate with the master station via a so-called drive telegram (AT) containing actual values, for example. An IP channel may possibly be included in a communication cycle, as well. A subsequent communication cycle then starts again with an MDT as collective telegram. The data telegrams used in this context have an “over-all check sum”, also known as FCS (frame check sequence), which is usually provided at the end of a telegram. After being received, the validity of the entire data telegram is checked using this FCS. Moreover, in an MDT as collective telegram, a plurality of data fields for various receiving (i.e., slave) stations is contained in the start. For example, they may simply be packed without gaps one after another into one telegram. The disadvantage in so doing is that, given a limitation of the maximum telegram length as in the case of the Ethernet, for instance, the maximum transmittable user data is limited.

According to the current state of the art, no method is yet specified as to how to handle a transmission of data which cannot be transmitted using a single telegram. However, this will be especially important in future Ethernet applications having a large bandwidth, for instance, where it must be expected that the quantity of data to be transmitted will be greater per telegram than the MTU already mentioned.

An object of the present invention is to provide a method for regulating a transmission of a quantity of user data to be transmitted between a plurality of users of a communication system via a field-bus system, as well as providing a communication system having a plurality of users and a field-bus system, and further providing a computer program product with program code for implementing the method according to the present invention.

### SUMMARY

According to the present invention, a method is provided for regulating a transmission of a quantity of user data to be transmitted between a plurality of users of a communication system via a field-bus system, in which the individual users communicate by way of data telegrams, each data telegram containing at least one destination address, one source address and a quantity of user data not exceeding a predefined, maximum quantity. In the event the quantity of user data predefined for a data telegram is less than the quantity of user data to be transmitted, the quantity of user data to be transmitted is fragmented into a plurality of partial telegrams, and the respective partial telegrams are transmitted in controllable fashion one after another in a sequence of partial telegrams.

In one example embodiment of the method according to the present invention, the respective partial telegrams within the sequence of partial telegrams are differentiated based on a telegram identifier. This means that a data block to be transmitted, or a quantity of user data to be transmitted is split up into a plurality of partial telegrams and transmitted one after another. By providing such partial telegrams, it is possible to overcome the limitation with regard to transmittable information or user data predefined by an MTU.

This means that, in the event a predefined MTU, such as an MTU of 1,500 bytes in the case of an Ethernet, is not sufficient for transmitting user data for an MDT or an AT, the user data is fragmented into a plurality of partial telegrams, and, for example, sent directly one after another. A differentiation is made between a first partial telegram and following telegrams based on a telegram identifier. Such a telegram identifier may be provided or filed in an arbitrary “telegram type” field.

In a further example embodiment of the method according to the present invention, the partial telegrams within the sequence of partial telegrams are logically linked together, so that the sequence of partial telegrams appears as a single data telegram for a transmitting and/or a receiving user of the communication system. That is to say, the user data in the partial telegrams of the sequence is logically linked together for a transmitting or a receiving user as though it were a single longer telegram.

In this context, it is conceivable for a receiving user to be able to automatically filter out partial telegrams addressed to it from the sequence of partial telegrams, based on a so-called “offset” stored in the user. Thus, a user does not necessarily have to receive and evaluate all telegrams in the sequence of partial telegrams.

In another example embodiment of the method according to the present invention, all user data to be sent to one receiver is stored and transmitted within a single partial telegram. This means that in the case when a data field of a receiver goes beyond the predefined quantity of transmittable user data of one partial telegram, using stuffing information at the end of the partial telegram, the beginning of this data field may be “shifted” to a following partial telegram. This procedure is also known as “padding”. Simpler processing algorithms may thereby be possible in the users. For example, the user data intended for one user may thus be copied to one block. A data field which normally lies at an offset of 1,498 . . . 1,508, for example, in the case of an MTU of 1,500 bytes, may be shifted to 1,500 . . . 1,510. Such a padding with stuffing information at the end of the partial telegrams may not be necessary if each user knows the exact length of the individual partial telegrams.

In a further example embodiment of the method according to the present invention, in the case of a cyclic synchronizing communication system, one partial telegram from the sequence of partial telegrams is selected as synchronizing telegram, identified as such and communicated as such to all users of the communication system. This means that in the case of a cyclically synchronizing communication system, synchronization information is transmitted one time per communication cycle. As already mentioned, the synchronization information is stored in a so-called MST data field of the corresponding partial telegram. For example, the telegram selected as synchronizing partial telegram is identified as such via the “telegram type” field. This agreement reached must be known or communicated to all users. This may be established either via a global agreement, for instance, or via an initialization. Advantageously, the first sequence telegram from the sequence of partial telegrams carries out the synchronization. The MST data field generally provided in the other remaining sequence telegrams may optionally be omitted.

In another example embodiment of the method according to the present invention, individual transmission times are predefined for the individual partial telegrams. In so doing, it is conceivable to transmit the individual partial telegrams from the sequence of partial telegrams at transmission times that are directly one after another, without further telegrams in between. This is carried out taking minimum telegram intervals into account, depending on the system.

Alternatively, however, when using an arbitrary transmit sequence, the partial telegrams may also be recognized based on the telegram identifier. In this case, one speaks of a recognition “on the fly.”

Moreover, a stipulation of the transmission times for the individual partial telegrams may also be communicated, so that the users are able to assign the individual partial telegrams based on the moment of receipt.

It is conceivable to use the communication system for communication in real-time systems.

In a further example embodiment of the method according to the present invention, the communication system is a communication in recurrent cycles.

In this context, it is possible for the communication cycles to possess a structure that is agreed to upon initialization, and is constant during further operation.

In another example embodiment of the method according to the present invention, the communication system is used for synchronizing users of the communication system.

In the case of a cyclic, synchronizing communication system, it is conceivable for one partial telegram from the sequence of partial telegrams to be selected as synchronizing telegram, identified as such and communicated as such to all users.

In a further example embodiment of the method according to the present invention, the communication system is based on an Ethernet protocol.

It is further conceivable to use the communication system for automation purposes.

In addition, the communication system may be used for drive synchronization, for drive control, for the input/output of input/output data and/or for measuring purposes.

The present invention further provides a communication system having a plurality of users and a field-bus system, in which the users communicate using the field-bus system by way of data telegrams, each data telegram including at least one destination address, one source address and a quantity of user data not exceeding a predefined maximum quantity. The communication system includes a control unit which compares the quantity of user data to be transmitted to the quantity predefined for one data telegram, and in the event the quantity of user data to be transmitted is greater than the predefined quantity, fragments the quantity of user data to be transmitted into a plurality of partial telegrams, and transmits the respective partial telegrams in controlled fashion one after another in a definable sequence of partial telegrams.

It is conceivable that, in the communication system, the respective partial telegrams within the sequence of partial telegrams are able to be differentiated based on a telegram identifier.

In a further example embodiment of the communication system, the control unit links the partial telegrams within the sequence of partial telegrams logically together, so that the sequence of partial telegrams acts or appears as a single data telegram for a transmitting and/or a receiving user.

It is further conceivable that partial telegrams addressed to one receiving user are able to be filtered out automatically from the sequence of partial telegrams by the receiving user, based on an offset stored in the user.

Moreover, all user data to be transmitted to one receiver may be stored within a single partial telegram.

In a further example embodiment of the communication system according to the present invention, in the case of a cyclic, synchronizing communication system, one partial telegram from the sequence of partial telegrams is selectable as synchronizing telegram, able to be identified as such and communicable as such to all users.

The present invention further provides a use of the method according to the invention in a communication system having a limited data-telegram size predefined as the largest possible. For example, such a communication system is the Ethernet already mentioned, or also a communication system known as SERCOS interface (serial realtime communication system).

Moreover, the present invention provides a computer program having program code which is configured for carrying out a method according to the present invention when executed on a computer or a computer system.

The present invention further provides a computer program product having program code, which is stored on a computer-readable data carrier in order to carry out a method of the present invention when the computer program is executed on a computer.

### BRIEF DESCRIPTION OF THE DRAWINGS

FIG. 1 shows schematically the conventional structure of a data telegram.

FIG. 2 shows schematically the structure of a data telegram according to an example embodiment of the method according to the present invention.

FIG. 3 shows schematically a splitting of user data into a plurality of partial telegrams according to one example embodiment of the method according to the present invention.

FIG. 4 shows schematically a splitting of user data into a plurality of partial telegrams according to another example embodiment of the method according to the present invention.

### DETAILED DESCRIPTION

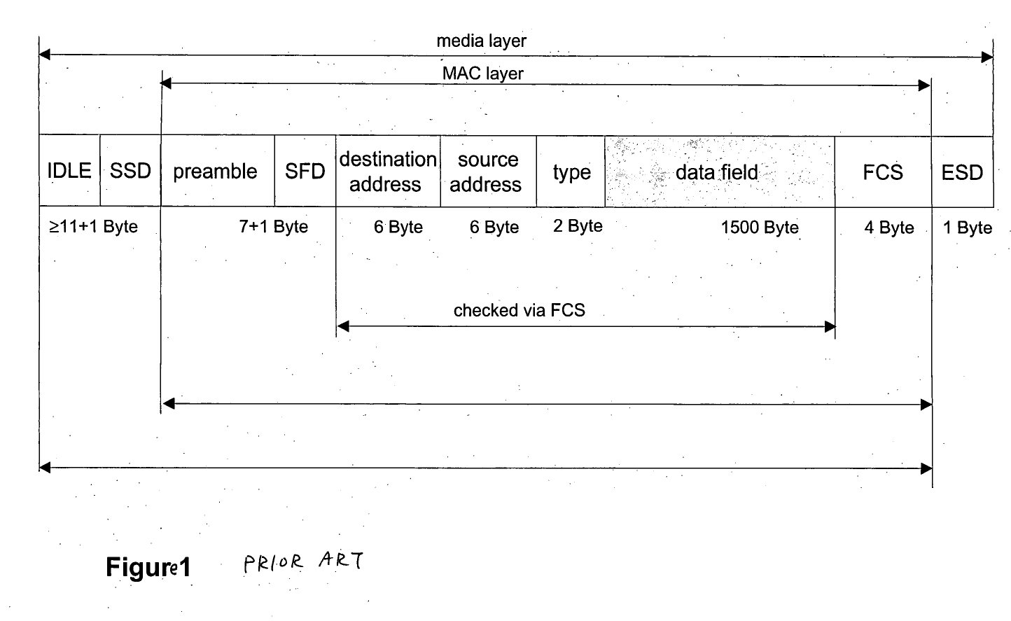

FIG. 1 shows schematically a structure of a typical data telegram. Preceding the data telegram is a character known as “IDLE,” which may have a size of ≧11 bytes. This character ensures that potential receivers of following data telegrams remain activated and ready to receive even when data telegrams are not being sent. Following the IDLE comes a so-called SSD (start stream delimiter), which indicates that a data telegram will follow. The actual data telegram begins with a “preamble” and a so-called SFD (start frame delimiter). In the case shown here, it may be a so-called master data telegram (MDT), for instance, which relays data to so-called slaves. Such an MDT is sent to all further users, the slaves, connected to the communication system, and is evaluated by all these users. This means that an MDT is a so-called broadcast telegram. The users or slaves are able to determine what location in the data telegram contains the information for them or addressed to them based on an offset stored in each of them. It may further be a so-called drive telegram AT, as well, which is transmitted by a slave to a corresponding master.

The MDT or AT begins with a specification of the destination address and the source address. This is followed by a field which contains the type or the length (type/length) of the data telegram. This field includes either the telegram type or the telegram length. Such a specification of a telegram type is filed here according to a standard agreement which was established or selected globally on the part of an international association. The telegram type indicated here gives information about what a following data field contains or how its contents are to be interpreted. It is noted whether it is an IP data field or a data field for a real-time communication, as is used for a SERCOS interface (serial realtime communication system), for example. The previously mentioned information, namely, destination address, source address and type/length information, is also contained in other telegrams such as data telegrams and prompt telegrams.

In the case of an MDT, it is further noted in the destination address that the MDT is directed to all users, thus, as already mentioned, is a broadcast telegram. Following after that, in a field “data field,” is user data for the users, addressed to them in accordance with the offset stored in each case. At the conclusion of the data telegram, a so-called FCS character is transmitted. This character FCS (frame check sequence) is used for safeguarding data by checksumming. The data field of the MDT is limited in its length, like in the case of an Ethernet to, e.g., 1,500 bytes. The quantity of user data addressed to the respective users is thereby also limited, which means that often not all user data to be transmitted can be transmitted to the individual users. A character ESD (end stream delimiter) indicates the end of the data telegram.

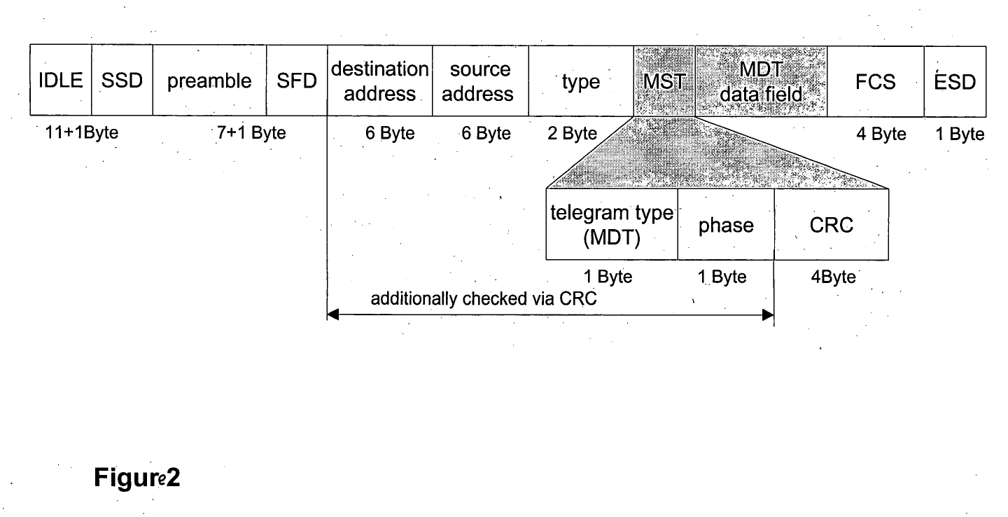

FIG. 2 shows an example embodiment of an MDT the way it may be constructed according to the present invention. Like the data telegram described in FIG. 1, as well, the MDT shown here begins with specification of a destination address and a source address. This information is followed by a field which contains the type or the length (type/length) of the data telegram. This field includes either the telegram type or the telegram length. As already described in FIG. 1, here as well, such a specification of a telegram type is filed according to a standard agreement which was established or predefined globally on the part of an international association. The telegram type indicated here gives information about what a following data field contains or how its contents are to be interpreted. It is noted whether it is an IP data field or a data field for a real-time communication, as is used for a SERCOS interface (serial real-time communication system), for example.

This is followed by synchronization information in a field MST (master synchronization telegram). In the case shown here, the MST is integrated into the data field. It is again subdivided into three fields. An identifier of the data telegram in question, such as here of the MDT, is indicated in a first field of the MST. Based on this identifier, it is possible to distinguish a specific data telegram from other subsequent or previous data telegrams. Thus, a succession of data telegrams may be handled according to a sequence definable by the identifier. This type of identifier must be differentiated from the statement of a telegram type, as made in the field preceding the data field. In a further field denoted as “phase,” information is given about the system state. Transmitting information concerning the system state provides for synchronization of the system time at all users of the communication system. Optionally, a further field CRC may be provided. This field provides for an additional check of the statements made up to then concerning the data telegram in question.

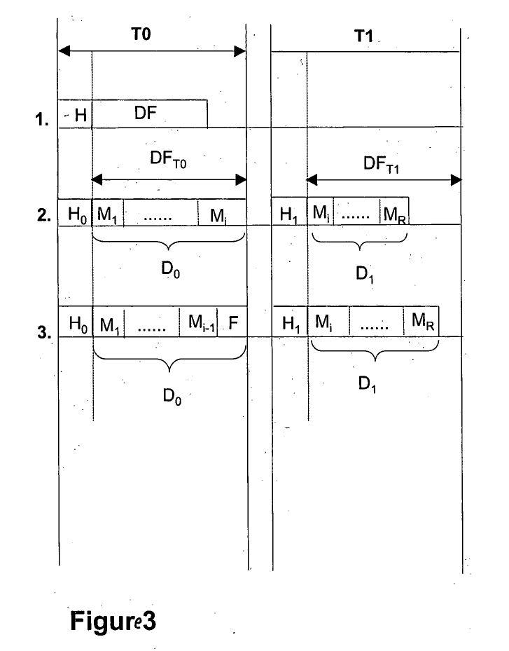

FIG. 3 shows a schematic depiction of three case examples 1 to 3, in which specific quantities M₁ to M_{R} of user data D are to be transmitted to respective receiving users 1 to R using data telegrams such as MDTs. In cases 2 and 3, the quantity of user data to be transmitted is fragmented into a plurality of partial telegrams.

In case 1, data telegram T0 shows a so-called header H which contains all essential information for the transmission of a data telegram already mentioned in FIG. 1. Following header H, a data field DF is shown which contains all user data to be transmitted by data telegram T0. In the case of data telegram T0, the quantity of user data to be transmitted is less than a predefined, maximally transmittable quantity MTU which, for example, lies at 1,500 bytes in the case of an Ethernet. Therefore, all user data may be transmitted here by a single data telegram, i.e., fragmentation of the user data into a plurality of partial telegrams is not necessary here.

In case 2, on the other hand, the MTU of a data telegram is not sufficient to send all user data D to be transmitted in case 2 in a single data telegram. Here, user data D is now distributed over two successive partial telegrams T0 and T1. The sum of user data D₀ and D₁ distributed over the partial telegrams corresponds to D. Both partial telegrams have a header H₀ and H₁, respectively. In the case shown here, the MTU, that is, the length of data field DF_{T0} of partial telegram T0 is completely filled with user data to be transmitted. Only when data field DF_{T0} is occupied to its maximum with a user-data quantity D₀ is the remaining part of user data D₁ stored in partial telegram T1 and thereby transmitted. In this case, a quantity Mᵢ of user data intended for user i is divided up into the two partial telegrams T0 and T1.

Case 3 shows an alternative possibility to case 2 for fragmentation of user data into a plurality of partial telegrams. In the case shown here, specific quantities M₁ to M_{R} of user data are likewise to be sent to corresponding users 1 to R of a communication system via one or more data telegrams, such as one or more master data telegrams MDT by a master or a user of the communication system to the other users of a communication system. As already in case 2, a maximally transmittable quantity of user data predefined for the data telegram, i.e., a so-called MTU (maximum transmission unit), is not sufficient for transmitting the total amount of user data D here, either. Therefore, the data here is fragmented into two partial telegrams T0 and T1. In this context, the sum of user data D₀ transmitted in T0 and user data D₁ transmitted in T1 corresponds to the total amount of user data D. As in case 2, quantity Mᵢ of user data to be transmitted for a receiving user i goes beyond the length of the data field of a partial telegram here, as well. In the case shown here, using so-called stuffing information F at the end of corresponding partial telegram T0, the beginning of the data field for receiving user i in question is now shifted to the next partial telegram T1. This is referred to as “padding.”

As an alternative to the case shown here, however, it is also conceivable for first partial telegram T0 to have a shorter length than the maximally transmittable length predefined for a data telegram, the so-called MTU (maximum transmission unit). In such an alternative case, first partial telegram T0 would be shortened, i.e., the mechanism of filling up data field “F” corresponding to a so-called “padding” which is marked in in case 3 shown here, would not be used in that instance.

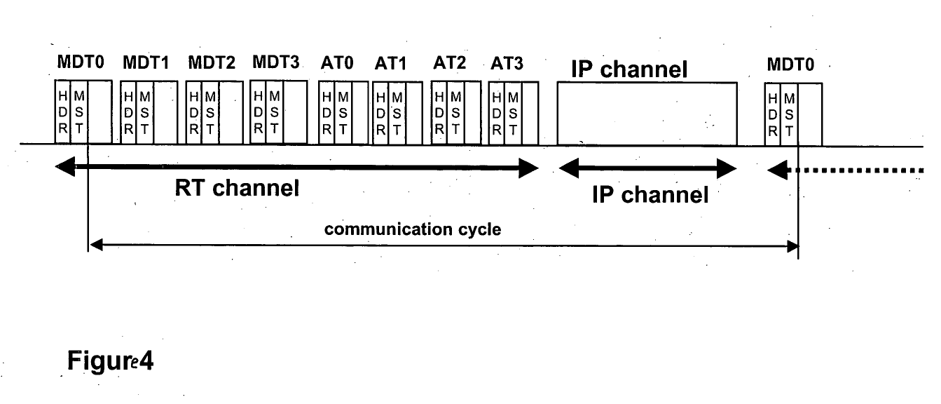

FIG. 4 shows a further possible fragmentation of user data into a plurality of partial telegrams. In this case, a complete communication cycle is shown, which includes one channel for real-time communication (RT channel) and one IP channel. The IP channel permits the transmission of either additional real-time-relevant data or data which is not real-time-critical. In the case shown here, MDTs and ATs are transmitted in the RT channel. The cycle is initiated by an MDT—MDT0—in which synchronization information is transmitted, among other things. The cycle is likewise ended by an MDT—MDT0—which at the same time begins a subsequent cycle. A sequence made up of four MDTs—MDT0 to MDT3—and four ATs—AT0 to AT3—is transmitted here in the RT channel. In a cyclic, synchronized communication shown here, one partial telegram from the sequence of partial telegrams is selected as synchronizing telegram. In the case shown here, first sequence telegram MDT0 may be selected for that purpose, identified as such and communicated as such to all users of the communication system. This means that synchronization information is transmitted one time per communication cycle. In this context, the synchronization information is filed in an MST data field of MDT0. The specific MST data field in the other remaining sequence telegrams may optionally be omitted.

As already mentioned, in the case of the Ethernet, the MTU is limited to 1,500 bytes. Thus, a sequence of partial telegrams T0 to TN results which are transmitted one after another, taking minimum telegram intervals into account, depending on the system. First partial telegram T0 of the sequence of partial telegrams may be differentiated from the following partial telegrams based on a telegram identifier. For example, such a telegram identifier may be inserted in a field “telegram type” of the MST, as explained in FIG. 2. The user data now filed in individual partial telegrams T0 to TN and thereby transmitted is logically linked together for the transmitting user or the receiving users as though it were a single longer data telegram. At the same time, the offset at which the user data addressed to the receiving users is contained, is stored in the receiving users. Based on such an offset of the data field addressed to the specific user, a receiving user is able to automatically filter out the partial telegrams intended for it from the sequence of partial telegrams. Therefore, a receiving user does not necessarily have to receive and evaluate all partial telegrams in a specific sequence of partial telegrams.

As mentioned, in the case of a cyclically synchronizing communication system, synchronization information is transmitted one time per communication cycle. As already mentioned in FIG. 2, this synchronization information is stored in a so-called MST data field. One of the partial telegrams from the sequence of partial telegrams may now be selected and identified as the synchronizing telegram. Such an identification may again be made via the field “telegram type.” An agreement made in such a way must be known or made known to all users of the communication system. Optionally, the MST data field of the partial telegrams which were not selected as synchronizing telegram is omitted. The first partial telegram from the sequence of partial telegrams advantageously carries out the synchronization.

As already mentioned, the transmission moments of the sequence telegrams are selected to be one after another. When using an arbitrary transmit sequence, recognition may optionally be carried out based on the telegram identifier, which corresponds to an “on-the-fly” recognition. Moreover, by stipulation of the transmission times, it is conceivable to permit the users to assign the individual partial telegrams based on the moment of receipt.

It is understood that the present invention has been explained in connection with the example embodiments which are not limiting, and the aforementioned features may be used not only in the combination indicated in each instance, but also in other combinations or by themselves, or modified, without departing from the scope of the present invention.

What is claimed is:

1. A method for regulating a transmission of a quantity of user data to be transmitted between a plurality of users of a communication system via a field-bus system, wherein the plurality of users communicate by using data telegrams, the method comprising:
providing in each data telegram at least one destination address, one source address, and a quantity of user data to be transmitted, wherein a predefined maximum quantity of user data for one data telegram is stipulated;
fragmenting the quantity of user data to be transmitted into a plurality of partial telegrams, if the predefined maximum quantity of user data for one data telegram is less than the quantity of user data to be transmitted; and
transmitting the plurality of partial telegrams one after another in a defined sequence.

2. The method as recited in claim 1, wherein each partial telegram within the defined sequence of partial telegrams is differentiated based on a telegram identifier.

3. The method as recited in one of claim 2, wherein the plurality of partial telegrams within the defined sequence of partial telegrams are logically linked together, whereby the defined sequence of partial telegrams appears as a single data telegram for at least one of a transmitting user and a receiving user.

4. The method as recited in claim 3, wherein the receiving user is able to automatically filter out partial telegrams addressed to the receiving user from the defined sequence of partial telegrams based on an offset stored in the user.

5. The method as recited in claim 3, wherein all user data to be transmitted to one receiver is stored and transmitted within a single partial telegram.

6. The method as recited in claim 3, wherein the communication system is used for communication in real-time systems.

7. The method as recited in claim 3, in which the communication system facilitates communication in recurrent communication cycles.

8. The method as recited in claim 7, wherein the recurrent communication cycles have a structure that is stipulated upon initialization, and the structure is constant during further operation.

9. The method as recited in claim 3, wherein individual transmission times for the individual partial telegrams are predefined.

10. The method as recited in claim 3, wherein the individual partial telegrams of the defined sequence of partial telegrams are transmitted at transmission times that are directly one after another, without any additional intervening telegrams that are not part of the defined sequence of partial telegrams.

11. The method as recited in claim 8, wherein the communication system facilitates synchronization of users of the communication system.

12. The method as recited in claim 8, wherein the communication system is a cyclic, synchronizing communication system, and wherein one partial telegram from the defined sequence of partial telegrams is selected and identified as a synchronizing telegram, and wherein the synchronizing telegram is communicated to all users.

13. The method as recited in claim 12, wherein the communication system is based on Ethernet protocol.

14. The method as recited in claim 13, wherein the communication system is used for automation purposes.

15. The method as recited in claim 13, wherein the communication system is used for at least one of: a) drive synchronization; b) drive control; c) input and output of data; and d) measuring purposes.

16. A communication system for a plurality of users communicating via a field-bus system by using data telegrams, wherein each data telegram includes at least one destination address, one source address, and a quantity of user data, the communication system comprising:
a control unit that compares the quantity of user data to be transmitted to a predefined maximum quantity of user data stipulated for one data telegram, wherein if the quantity of user data to be transmitted is greater than the predefined maximum quantity stipulated, the control unit fragments the quantity of user data to be transmitted into a plurality of partial telegrams, and wherein the control unit transmits the plurality of partial telegrams one after another in a defined sequence of partial telegrams.

17. The communication system as recited in claim 16, wherein each partial telegram within the defined sequence of partial telegrams is differentiated based on a telegram identifier.

18. The communication system as recited in claim 17, wherein the control unit logically links the plurality of partial telegrams within the defined sequence of partial telegrams together, whereby the defined sequence of partial telegrams appears as a single data telegram for at least one of a transmitting user and a receiving user.

19. The communication system as recited in claim 18, wherein partial telegrams addressed to the receiving user are able to be filtered out automatically from the defined sequence of partial telegrams by the receiving user, based on an offset stored in the user.

20. The communication system as recited in claim 18, wherein all user data to be transmitted to one receiver is stored and transmitted within a single partial telegram.

21. The communication system as recited in claim 18, wherein the communication system is a cyclic, synchronizing communication system, and wherein one partial telegram from the defined sequence of partial telegrams is selected and identified as a synchronizing telegram, and wherein the synchronizing telegram is communicated to all users.

22. A computer-readable medium for storing a program including a plurality of program codes for controlling, when executed by a computer, a method for regulating a transmission of a quantity of user data to be transmitted between a plurality of users of a communication system via a field-bus system, wherein the plurality of users communicate by using data telegrams, the method comprising:
providing in each data telegram at least one destination address, one source address, and a quantity of user data to be transmitted, wherein a predefined maximum quantity of user data for one data telegram is stipulated;
fragmenting the quantity of user data to be transmitted into a plurality of partial telegrams, if the predefined maximum quantity of user data for one data telegram is less than the quantity of user data to be transmitted; and
transmitting the plurality of partial telegrams one after another in a defined sequence.

23. A computer program product including a plurality of program codes for controlling, when executed by a computer, a method for regulating a transmission of a quantity of user data to be transmitted between a plurality of users of a communication system via a field-bus system, wherein the plurality of users communicate by using data telegrams, the method comprising:
providing in each data telegram at least one destination address, one source address, and a quantity of user data to be transmitted, wherein a predefined maximum quantity of user data for one data telegram is stipulated;
fragmenting the quantity of user data to be transmitted into a plurality of partial telegrams, if the predefined maximum quantity of user data for one data telegram is less than the quantity of user data to be transmitted; and
transmitting the plurality of partial telegrams one after another in a defined sequence.

24. A computer system for controlling, by executing a control program, a method for regulating a transmission of a quantity of user data to be transmitted between a plurality of users of a communication system via a field-bus system, wherein the plurality of users communicate by using data telegrams, wherein in each data telegram at least one destination address, one source address, and a quantity of user data to be transmitted are provided, and wherein a predefined maximum quantity of user data for one data telegram is stipulated, the computer system comprising:
a control unit for fragmenting the quantity of user data to be transmitted into a plurality of partial telegrams, if the predefined maximum quantity of user data for one data telegram is less than the quantity of user data to be transmitted, and facilitating transmission of the plurality of partial telegrams one after another in a defined sequence.
